(19) United States
(12) Patent Application Publication
(10) Pub. No.: US 2020/0063468 A1
(43) Pub. Date: Feb. 27, 2020

(54) LATCH ASSEMBLY HAVING INTEGRAL FASTENERS AND METHOD OF ASSEMBLING SAME

(71) Applicant: BAUER PRODUCTS, INC., Grand Rapids, MI (US)

(72) Inventor: Bruce C. Bacon, Rockford, MI (US)

(73) Assignee: BAUER PRODUCTS, INC., Grand Rapids, MI (US)

(21) Appl. No.: 16/106,100

(22) Filed: Aug. 21, 2018

(51) Int. Cl. E05B 79/04; E05B 83/22; E05B 85/02; E05B 85/22; E05B 85/10; B60P 3/36

(52) U.S. Cl. CPC E05B 79/04; E05B 83/22; B60P 3/36; E05B 85/22; E05B 85/10; E05B 85/02

(57) ABSTRACT

A door latch assembly for a closure pivotable between an open position and a closed position includes an inside housing and an outside housing in juxtaposed relation with one another and mounted to an opening in the closure to define an enclosure. A resilient integral latch post is substantially disposed upon and extending from one of the inside or outside housing, and a corresponding integral receptacle is substantially disposed upon the other of the inside or outside housing. The integral receptacle is aligned with the resilient latch post so as to receive and restrain a notch on the resilient latch post upon a catch on the integral receptacle and thereby secure the inside and outside housing one to the other.

### FIELD OF THE INVENTION

The present disclosure relates to latch assemblies for movable closures and the like, and, in particular, to a slam door latch assembly for a recreational vehicle storage compartment door that can be assembled without tools through the use of a plurality of integral fasteners.

### BACKGROUND OF THE INVENTION

Latch assemblies are generally well-known in the art, and may be flush mounted on an associated closure, such as a storage compartment door of a recreational vehicle, to facilitate selectively shifting the closure between an open position and a closed position. Such latch assemblies are typically equipped with a lock to secure the closure in the closed position. In the case of storage compartments doors used on recreational vehicles, manually actuated rotary latch lock assemblies are often used to secure the storage compartment door in the closed position.

Alternatively, so-called slam door latch assemblies are becoming increasingly more common as latch assemblies used to secure recreational vehicle storage compartment doors in the closed position. Such slam door latch assemblies may include an outside housing and an inside housing, within which is generally situated a retractable latch plunger that is readily displaced by contact with a latch striker mounted to the recreational vehicle proximate the opening for the recreational vehicle storage compartment door. The recreational vehicle storage compartment door can be closed without manual retraction of the retractable latch plunger and can thus be effectively “slammed” shut. An exterior paddle handle assembly mounted to the outside housing is operably coupled with the retractable latch plunger, whereby the retractable latch plunger may be shifted between a latched and an unlatched position. Typically, such slam door latch assemblies also include a lock that restrains the exterior paddle handle and thus prevents operation of the retractable latch plunger for security.

Heretofore, while such slam door latch assemblies have proven generally effective, they experience certain drawbacks. For example, it is sometimes difficult to align the outside housing and inside housing disposed on either side of the opening for the slam door latch assembly in the storage compartment door during the assembly process. Separate threaded fasteners used to operably couple the outside housing and the inside housing typically extend through openings extending through the inside housing that are received within a corresponding plurality of bosses situated on the outside housing. Thus, simultaneous alignment of each of the openings and each of the bosses may be problematic. Further, the installation of separate threaded fasteners to assemble the slam door latch assemblies, which typically number between two and four separate threaded fasteners per slam latch, is a relatively time-consuming and expensive process. Finally, the separate threaded fasteners themselves represent a cost of the slam door latch assembly. While individually these labor and material costs related to the installation of separate threaded fasteners may not be significant, in the case when hundreds of such slam door latch assemblies may be assembled per day, collectively the aforementioned costs may become significant. Hence, a slam door latch assembly that overcomes these drawbacks would be advantageous.

### SUMMARY OF THE INVENTION

According to one aspect of the present disclosure, a door latch assembly for a closure pivotable between an open position and a closed position is disclosed. The door latch assembly includes an inside housing and an outside housing in juxtaposed relation with one another and mounted to an opening in the closure to define an enclosure. A resilient integral latch post is substantially disposed upon and extending from one of the inside or outside housing and a corresponding integral receptacle is substantially disposed upon the other of the inside or outside housing. The integral receptacle is aligned with the resilient latch post so as to receive and restrain a notch on the resilient latch post upon a catch on the integral receptacle and thereby secure the inside and outside housing one to the other.

According to another aspect of the present disclosure, the door latch assembly includes an inside housing and an outside housing in juxtaposed relation with one another and mounted to an opening in a closure to define an enclosure. A retractable latch plunger is situated within the enclosure. A biasing member is mounted within the enclosure urging the retracted latch plunger to an extended latched position. An exterior handle assembly is mounted to the outside housing and operably coupled with the retractable latch plunger, whereby the retractable latch plunger may be shifted between the latched position and an unlatched position. A plurality of resilient integral latch posts is substantially disposed on the inside or outside housing and a corresponding plurality of integral receptacles is substantially disposed on the other of the inside or outside housing, wherein the plurality of integral receptacles are aligned with the plurality of resilient integral latch posts so as to receive and restrain a notch on each of the plurality resilient integral latch posts upon a catch on each of the plurality of integral receptacles and thereby operably connect the inside and outside housing one to the other.

According to a further aspect of the present disclosure, a method of assembling a door latch assembly for a closure pivotable between an open position and a closed position is disclosed. The door latch assembly includes an inside housing and an outside housing in juxtaposed relation with one another and mounted to an opening in the closure to define an enclosure, wherein the size of the opening in the closure is smaller than the periphery of each of the inside housing and an outside housing, a retractable latch plunger situated within the enclosure, a biasing member mounted within the enclosure urging the retracted latch plunger to an extended latched position, an exterior handle assembly mounted to the outside housing and operably coupled with the retractable latch plunger, whereby the retractable latch plunger may be shifted between the latched position and an unlatched position, a plurality of resilient integral latch posts extending from the outside housing, each of the plurality of resilient integral latch posts further comprising a notch disposed at a distal end, a corresponding plurality of integral receptacles, each of the plurality of integral receptacles comprising an opening disposed on the inside housing, the opening further defining a catch on an edge thereof. The method comprises the steps of disposing the inside housing adjacent an interior surface of the closure and proximate the opening in the closure, disposing the outside housing adjacent an outside surface of the closure and proximate the opening in the closure, aligning the plurality of resilient integral latch posts with the plurality of integral receptacles, and moving the inside housing and the outside housing together to push the notch on each of the plurality of resilient integral latch posts into registration with the catch on the plurality of integral receptacles and thereby operably couple the inside and outside housing one to the other.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a front side perspective view of a recreational vehicle provided with storage compartment door assemblies in accordance with the present disclosure;

FIG. 2 is a plan exterior view of the exterior surface of one of the storage compartment door assemblies shown in FIG. 1, further showing the exterior surface of the outside housing of the door latch assembly;

FIG. 3 is a plan view of a portion of the interior surface of the storage compartment door assembly, further showing the interior surface of the inside housing of an embodiment of the door latch assembly shown in FIG. 2;

FIG. 4 is a perspective view of a portion of the interior surface of the storage compartment door assembly and the interior surface of the inside housing of the first embodiment of the door latch assembly shown in FIG. 3, along with a latch striker mounted proximate an edge of the opening for the storage compartment door assembly;

FIG. 5 is another perspective view of the embodiment of the door latch assembly shown in FIG. 2;

FIG. 6 is a cross-sectional view of a portion of the embodiment of the door latch assembly shown in FIG. 5, taken along the line VI-VI in FIG. 5;

FIG. 7 is a side view of a portion of the embodiment of the door latch assembly shown in FIG. 2;

FIG. 8 is a perspective view of the inner face of the outer housing of the embodiment of the door latch assembly shown in FIG. 2;

FIG. 9 is another perspective view of the inner face of the outer housing of the embodiment of the door latch assembly shown in FIG. 2;

FIG. 10 is perspective view of the inner face of the inner housing of the embodiment of the door latch assembly shown in FIG. 2;

FIG. 11 is a perspective exploded view of the embodiment of the door latch assembly shown in FIG. 2;

FIG. 12A is a perspective cross-sectional view of another embodiment of the door latch assembly shown in FIG. 2; and

FIG. 12B is an enlarged perspective cross-sectional view of the door latch assembly shown in FIG. 12A.

### DETAILED DESCRIPTION OF THE PREFERRED EMBODIMENT

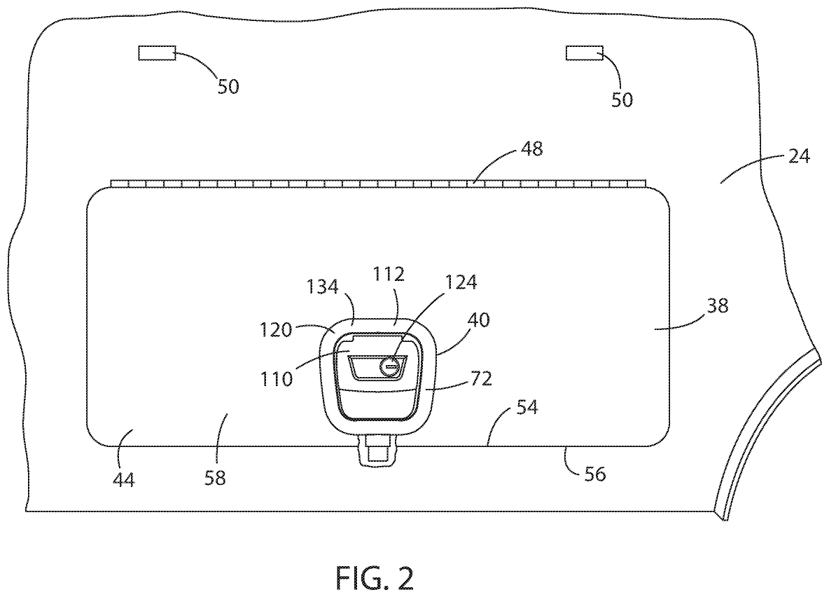

For purposes of description herein, the terms “upper,” “lower,” “right,” “left,” “rear,” “front,” “vertical,” “horizontal,” “interior,” “exterior,” and derivatives thereof shall relate to the invention as oriented in FIGS. 2 through 4. However, it is to be understood that the invention may assume various alternative orientations, except where expressly specified to the contrary. It is also to be understood that the specific devices and processes illustrated in the attached drawing, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

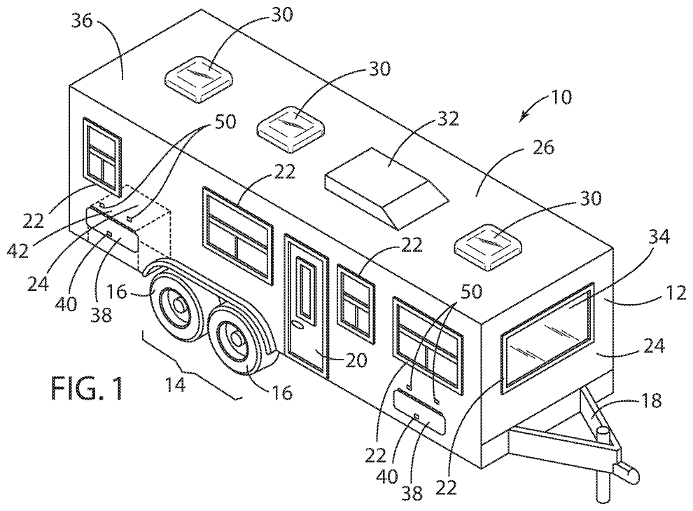

Referring to FIG. 1, reference numeral 10 generally designates a recreational vehicle travel trailer particularly adapted for being towed by a motor vehicle (not shown). However, other recreational vehicle 10 configurations may advantageously employ the benefits of the present disclosure, such as and including motor coaches and so-called fifth-wheel travel trailers. In the embodiment contemplated herein, the recreational vehicle 10 generally comprises a body 12 that is primarily supported by a pair of axles 14, each comprising at least one pair of opposing road wheels and an axle assembly 16, and a trailer tongue 18 by which the recreational vehicle 10 may be attached to the tow vehicle. As is typical, the recreational vehicle 10 has an entry door assembly 20 for egress and ingress and a plurality of windows 22 arranged on exterior side walls 24 of the body 12. A roof portion 26 is provided to enclose the body 12 and typically includes one or more ceiling vents 30, typically arranged along the longitudinal length of the recreational vehicle 10. Optionally, an air conditioning unit 32 can be mounted on the roof portion 26 as well.

The storage compartment door assembly 38, to which the door latch assembly 40 of the present disclosure may be applied, is primarily installed to provide access to the interior of a storage compartment 42 through the exterior side walls 24 of the body 12 of the recreational vehicle 10. That is, the storage compartment door assembly 38 is typically operable between a closed position, in which the contents of the storage compartment 42 may be secured and the elements, such as the rain, snow, and wind, may be sealed from the interior 34 of the body 12 of the recreational vehicle 10, and an open position, by which access to the interior of the storage compartment 42 and the contents secured therein may be allowed relative the exterior sidewalls 24 of the body 12 of the recreational vehicle 10.

Typically, such storage compartments 42 and corresponding storage compartment door assemblies 38 are arranged about the exterior of the recreational vehicle 10 at locations and in quantities and capacities as may be dictated by the design of the recreational vehicle 10 and the needs of the users of the recreational vehicle 10. As shown in FIG. 1, two such storage compartments 42 and corresponding storage compartment door assemblies 38 are depicted. However, it should be understood that the door latch assembly 40 of the present disclosure can be used in a wide variety of such storage compartments 42 and corresponding storage compartment door assemblies 38, as will be made evident to those skilled in the art in accordance with the instant disclosure.

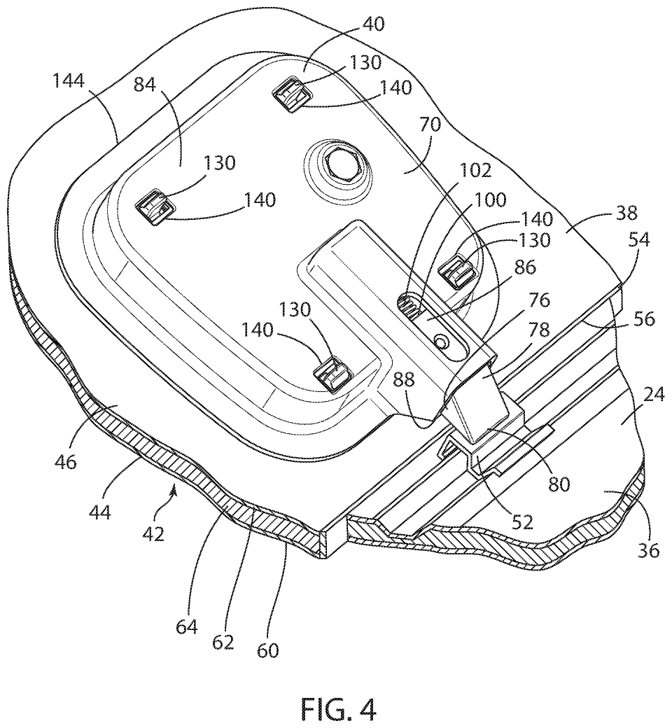

As shown in FIGS. 2 and 4, the storage compartment door assembly 38 primarily consists of a closable door panel 58 having an exterior surface 44 and an interior surface 46 mounted to the exterior sidewalls 24 of the body 12 of the recreational vehicle 10 by a horizontal hinge assembly 48, typically a piano-type hinge. Thus, the storage compartment door assembly 38 may be pivoted between the open position and the closed position. Typically, a retainer latch or magnet assembly 50 is mounted above the storage compartment door assembly 38 to releasable maintain the storage compartment door assembly 38 in the open position until the operator desires to close the same.

The storage compartment door assembly 38 is further provided with the door latch assembly 40 disposed on a side of the storage compartment door assembly 38 opposite the side having the hinge assembly 48. The door latch assembly 40 preferably engages a corresponding latch striker 52 on an interior surface 36 of the storage compartment 42, as best shown in FIG. 4. Preferably, the latch striker 52 is mounted near an edge 54 of the storage compartment door assembly 38 and proximate the opening 56 for the storage compartment door assembly 38. The closable door panel 58 of the storage compartment door assembly 38 may be formed by an aluminum or fiberglass clad exterior panel 60, an aluminum or fiberglass clad interior panel 62, and a filler material 64 disposed between the exterior and interior panels 60, 62. The filler material 64 may consist of a structural foam material that provides structural support, as well as high insulating qualities, at an extremely low weight.

The door latch assembly 40 of the storage compartment door assembly 38 generally includes an inside housing 70 and an outside housing 72 in juxtaposed relation with one another and mounted to an opening 74 in the closable door panel 58 of the storage compartment door assembly 38 to define an enclosure 75, as perhaps best shown in shown in FIG. 12A. That is, the inside housing 70 and the outside housing 72 are operably connected to each other through the opening 74 in the closable door panel 58 of the storage compartment door assembly 38, wherein the closable door panel 58 of the storage compartment door assembly 38 is disposed between the inside housing 70 and the outside housing 72. Preferably, the size of the opening 74 in the closable door panel 58 of the storage compartment door assembly 38 is smaller than the periphery of each of the inside housing 70 and the outside housing 72, such that when the inside housing 70 and the outside housing 72 are operably coupled and the door latch assembly 40 of the storage compartment door assembly 38 is finally assembled, the enclosure 76 and the storage compartment 42 are essentially sealed from the elements.

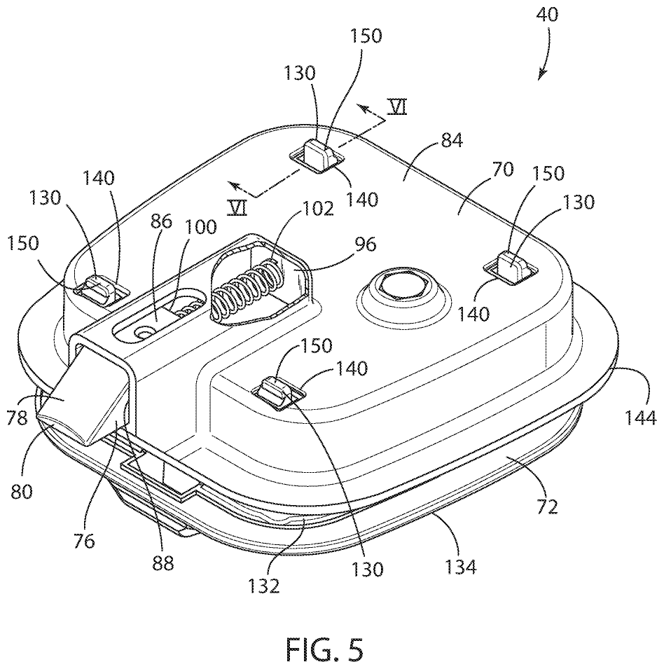

As perhaps may be best appreciated from FIG. 2, a preferred embodiment of the door latch assembly 40 of the storage compartment door assembly 38 is a slam door latch assembly 40, which may include a retractable latch plunger 76 having an inclined surface 78 at an exposed distal end 80, such that the inclined surface 78 faces the latch striker 52 when the storage compartment door assembly 38 is in the open position. The retractable latch plunger 76 is moveable within the inside housing 70 between an extended position and a retracted position, wherein the inside housing 70 is further provided with an elongated recess 82. The retractable latch plunger 76 is preferably slidably mounted within the elongated recess 82, which is even more preferably disposed on the interior surface 84 of the inside housing 70, as shown in FIGS. 4, 5, 7, 10, 11, and 12.

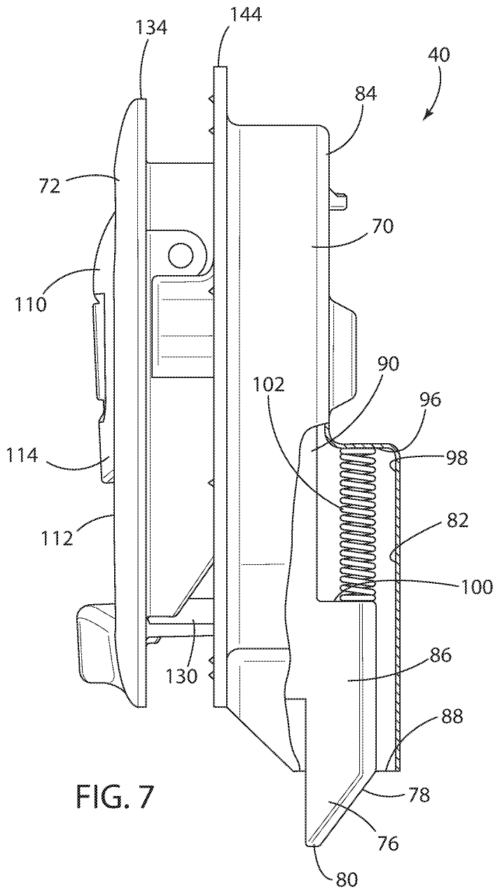

As seen in FIG. 7, the retractable latch plunger 76 comprises a main body 86 received within the elongated recess 82 disposed within the inside housing 70. The elongated recess 82 is preferably provided with an opening 88 proximate the distal end 80 of the retractable latch plunger 76, whereby the opening 88 is essentially flush with the edge 54 of the closable door panel 58 of the storage compartment door assembly 38. The retractable latch plunger 76 also includes an offset portion 90, upon which a leg 92 of a rotatably mounted latch cam 94 may be operably coupled, such that the rotation of the latch cam 94 displaces the leg 92 and thereby retracts the retractable latch plunger 76 to a retracted position within the elongated recess 82 disposed on the interior surface 84 of the inside housing 70.

The elongated recess 82 preferably includes a first spring seat 96 at a first end 98 of the elongated recess 82, and the main body 86 of the retractable latch plunger 76 preferably includes a second spring seat 100, whereby a biasing member 102 may be mounted within the inside housing to urge the retractable latch plunger 76 to the extended position. Preferably, the biasing member comprises a compression spring 102 disposed in axial alignment with the retractable latch plunger 76 within the elongated recess 82, such that the compression spring 102 is disposed between the first spring seat 96 and the second spring seat 100.

The retractable latch plunger 76 is thus readily displaced to its retracted position by contact of the inclined surface 78 at its exposed distal end 80 with the latch striker 52 mounted to the recreational vehicle proximate the opening 56 for the storage compartment door assembly 38, as best shown in FIG. 4. Thus, as noted above, the storage compartment door assembly 38 so equipped with the door latch assembly 40 can be closed without manual retraction of the retractable latch plunger 76 and may be simply “slammed” shut.

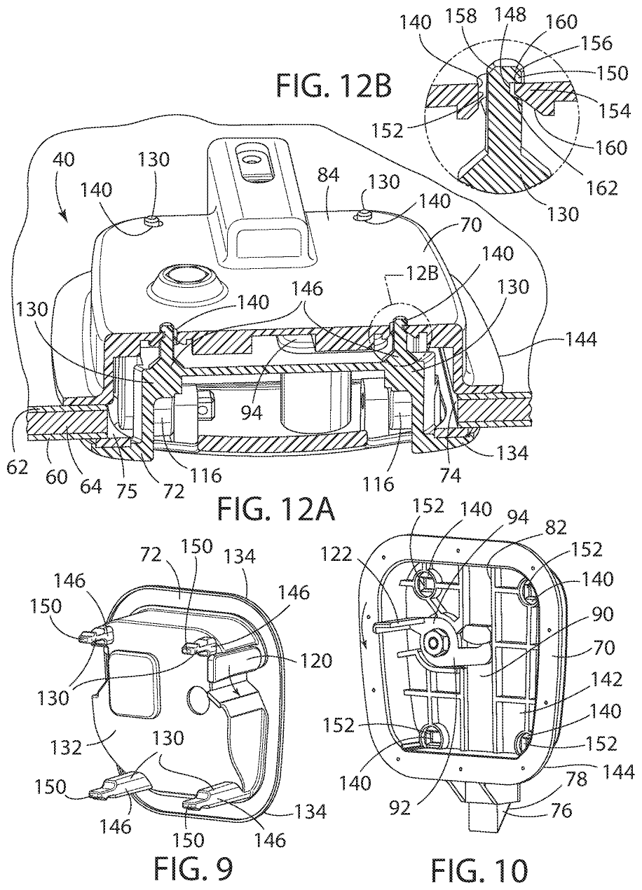

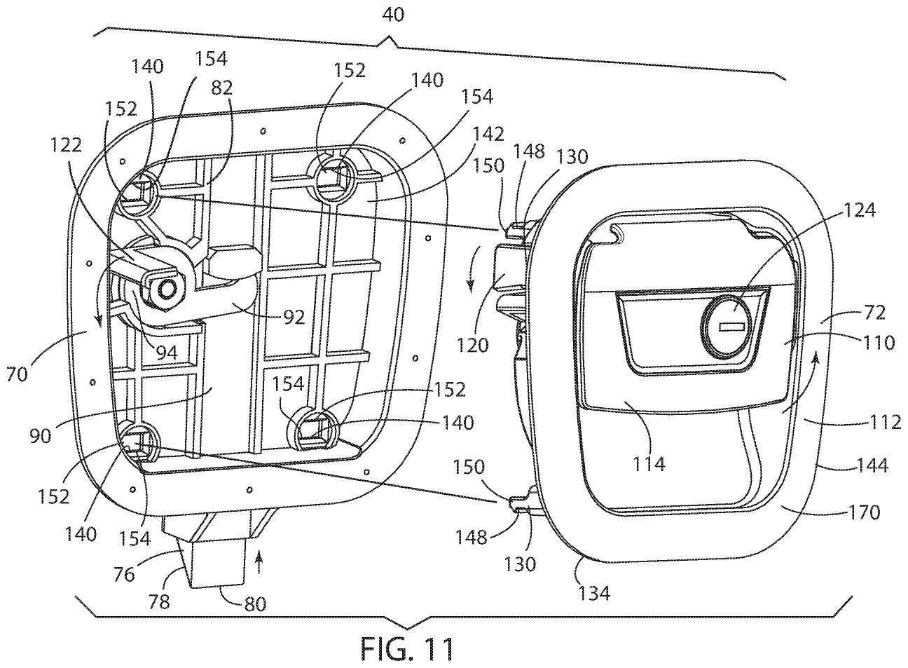

As shown in FIGS. 2 and 11, an exterior paddle handle assembly 110 may be mounted to the outer surface 112 of the outside housing 72. The exterior paddle handle assembly 110 may include an exterior paddle handle 114, a pivot mount 116, an optional return torsion spring 118, and an actuating lever 120. The exterior paddle handle 114 may be operably coupled with the retractable latch plunger 76 via the actuating lever 120, which is operably coupled with the exterior paddle handle 114, as shown in FIG. 9. The actuating lever 120 is, in turn, operably coupled with an arm 122 disposed on the latch cam 94 and extending outwardly parallel to the axis of rotation of the latch cam 94. Thus, upward rotation of the exterior paddle handle 114 from a closed position to an open position displaces the actuating lever 120, which depresses the arm 122 on the latch cam 94, thereby rotating the latch cam 94. As noted above, such rotation of the latch cam 94 displaces the leg 92 of the latch cam 94 and retracts the offset portion 90 of the retractable latch plunger 76 to a retracted position within the elongated recess 82 disposed on the interior surface 84 of the inside housing 70, whereby the retractable latch plunger 76 may be shifted from the latched position to its unlatched position. Upon shifting the retractable latch plunger 76 to its unlatched position, the recreational vehicle storage compartment door assembly 38 may be readily shifted to its open position.

The return torsion spring 118 may be provided to return the exterior paddle handle 114 to the closed position when released by the operator and thereby allow the retractable latch plunger 76 to return to its extended position within the elongated recess 82 disposed to within the inside housing 70 by the urging of the compression spring 102. Alternatively, the torsion spring 118 may be omitted in favor of a suitably stiff compression spring 102. That is, the retractable latch plunger 76 is operably coupled with the latch cam 94, which is in turn operably coupled with the exterior handle assembly 110, including the exterior paddle handle 114. Displacement and return of the retractable latch plunger 76 to its extended position by the compression spring 102 thus displaces the offset portion 90 of the retractable latch of plunger 76, which in turn rotates the latch cam 94 clockwise, as shown in FIG. 10, to urge the exterior paddle handle 114 to the closed position. In either case, when the storage compartment door assembly 38 so equipped is in the open position, it may now be simply “slammed” shut. If the storage compartment door assembly 38 so equipped is in the closed position, the distal end 80 of the retractable latch plunger 76 is disposed adjacent the latch striker 52, as shown in FIG. 4, and the recreational vehicle storage compartment door is maintained in the closed position. Typically, such slam door latch assemblies 40 also include a lock cylinder 124 that is situated to restrain the exterior paddle handle 114 when in the locked condition and thus prevent operation of the retractable latch plunger 76 for maximum security, as is known in the art.

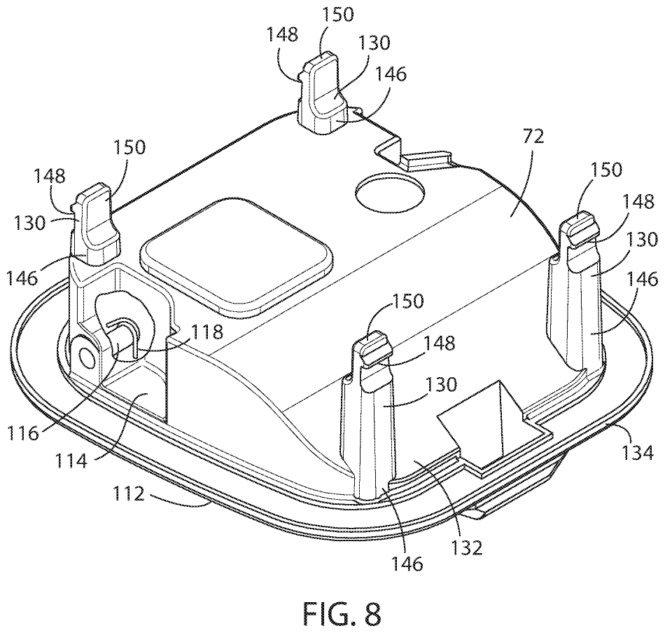

As a particularly advantageous feature of the present disclosure, a plurality of resilient integral latch posts 130 are preferably disposed on the inner face 132 of the outside housing 72, as perhaps best seen in FIGS. 8 and 9. Each of the resilient integral latch posts 130 preferably extends inwardly from the inner face 132 of the outside housing 72. A corresponding plurality of integral receptacles 140 may be disposed on an inner face 142 of the inside housing 70, as best seen in FIGS. 10 and 11, such that each of the integral receptacles 140 are aligned with one of resilient integral latch posts 130 so as to receive and restrain the resilient integral latch posts 130 within the integral receptacles 140 and thereby secure the inside housing 70 and outside housing 72 one to the other.

Preferably, each of the plurality of resilient integral latch posts 130 is substantially disposed proximate and about the perimeter 134 of the outside housing 72. In turn, the corresponding plurality of integral receptacles 140 is preferably and substantially disposed proximate and about the perimeter 144 of the inside housing 70. In the embodiments disclosed herein, the door latch assembly 40 is essentially square and preferably four resilient integral latch posts 130 are disposed about the perimeter 134 of the outside housing 72 and four corresponding integral receptacles 140 are disposed about the perimeter 144 of the inside housing 70 proximate each corner of the door latch assembly 40.

Alternatively, although not shown, the plurality of resilient integral latch posts 130 may be substantially disposed on opposed sides of one of the outside housing 72 and the corresponding plurality of integral receptacles 140 may be disposed on opposed sides of the inside housing 70. As a further alternative, also not shown, depending on the location and configuration of the paddle handle assembly, the plurality of resilient integral latch posts 130 and corresponding plurality of integral receptacles 140 may be disposed at locations proximate a more central location of the door latch assembly 40. Finally, again depending on the location and configuration of the paddle handle assembly, it is contemplated that a single, centrally located resilient integral latch post 130 and a corresponding single, centrally located integral receptacle 140 may advantageously employ the benefits of the door latch assembly 40 disclosed herein.

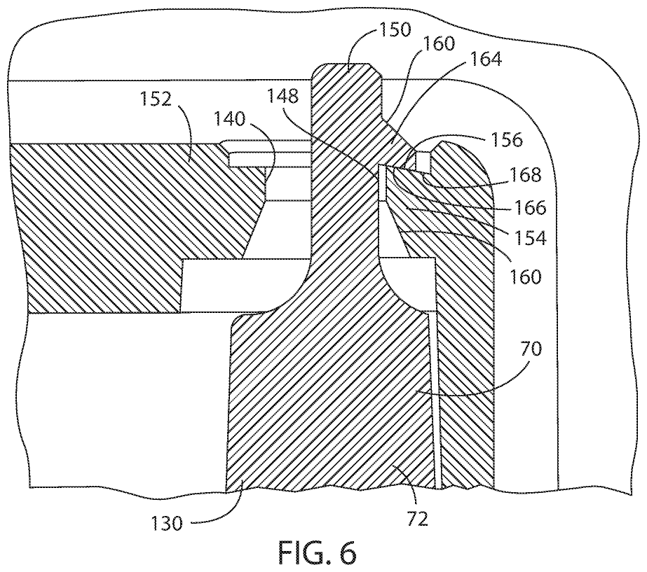

Preferably, each of the resilient integral latch posts 130 comprises a proximal end 146 thereof integrally formed with the outside housing 72 and a notch 148 at a distal end 150 thereof, as best shown in FIGS. 6, 8, 11, and 12A. Each of the integral receptacles 140 preferably comprises an opening 152 having a catch 154 disposed on a portion of the edge 156 of each of the openings 152 upon which the notch 148 is operably coupled after assembly, as best shown in FIGS. 6, 10, 11, and 12A. Thus, the resilient integral latch posts 130 extend through the integral receptacles 140 during and after assembly.

The plurality of integral receptacles 140 preferably comprises the plurality of openings 152 though the inside housing 70 through which the plurality of resilient integral latch posts 130 extend during and after assembly. Alternatively, although not shown, the integral receptacles 140 may be integrally molded as a blind hole having the catch 154 disposed therein, as discussed further below. However, in such configuration, it may be difficult to disassemble the door latch assembly 40 by manually disengaging the resilient integral latch posts 130 from the integral receptacles 140 after assembly by displacing the notch 148 on the resilient integral latch posts 130 relative the catch 154 in the integral receptacles 140 to allow the withdrawal of the resilient integral latch posts 130 from the integral receptacle 140 after assembly.

When formed as the opening 152, the opening 152 of the plurality of integral receptacles 140 may be formed as a circular opening 152, as shown in the embodiment depicted in FIG. 12A. However, it should be appreciated that the opening 152 of the plurality of integral receptacles 140 may also be formed in other configurations, such as an oval or elliptical configuration. In the embodiment shown in FIG. 12A, each of the plurality of resilient integral latch posts 130 are formed in an essentially cylindrical configuration, where the notch 148 is formed at the distal end 150 thereof. In this configuration, the distal end 150 of each of the plurality of resilient integral latch posts 130 is also preferably provided with a chamfered edge 158, which defines an inclined cam surface 160, as further discussed below. As shown in FIGS. 12A and 12B, the notch 148 is simply formed by removing material at the distal end 150 of each of the plurality of resilient integral latch posts 130 to form a recess 162. The recess 162 preferably comprises an orthogonal portion adapted to engage with the catch 154 on the plurality of integral receptacles 140. The notch 148 may adopt other configuration, as further described below.

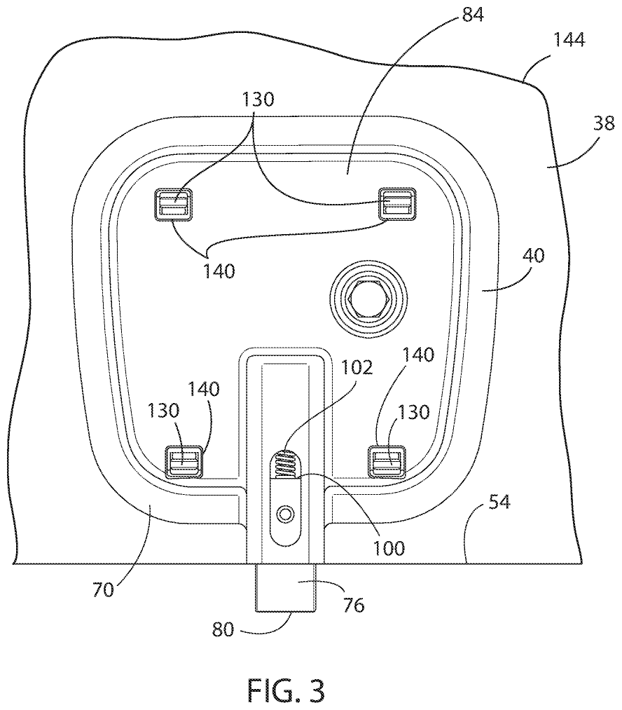

Even more preferably, the openings 152 of each of the plurality of integral receptacles 140 are substantially rectangular, and one side edge 156 of the substantially rectangular opening 152 defines the catch 154, as particularly shown in the embodiment depicted in FIG. 6, as well as FIGS. 3-5, 10, and 11. In addition, each of the plurality of resilient integral latch posts 130 are also preferably formed as a substantially rectangular prism disposed between the proximal end 146 and the distal end 150, as shown in the embodiment depicted in FIGS. 3-6, 8, 9, and 11. In this embodiment, the notch 148 is preferably formed as a snap hook 164 disposed at the distal end 150 of each of the plurality of resilient integral latch posts 130. The snap hook 164 preferably has an undercut 166, as perhaps best seen in FIG. 6. The catch 154 on the side edge 156 of the opening 152 of the plurality of integral receptacles 140 is further preferably formed having a reverse incline 168 to which the undercut 166 of the snap hook 164 may be operably coupled.

At least one of each of the resilient integral latch posts 130 or the integral receptacles 140 preferably comprises an inclined cam surface 160, respectively, facing the other of the resilient integral latch posts 130 or the integral receptacles 140, whereby as each of the resilient integral latch posts 130 is inserted within its corresponding integral receptacle 140, the distal end 150 of the resilient integral latch post 130 is displaced by the inclined cam surface 160 inward toward the central axis of the integral receptacle 140 during and after the assembly process. Even more preferably, both the resilient integral latch posts 130 and the integral receptacles 140 each comprises complimentary facing and interacting inclined cam surfaces 160 facing the other of the resilient integral latch posts 130 and the integral receptacles 140, as shown in FIGS. 6 and 12, whereby the resilient integral latch posts 130 are displaced relative the integral receptacles 140, that is, inward toward the central axis of integral receptacles 140, thereby allowing the resilient integral latch posts 130 to extend into the plurality of integral receptacles 140 during and after assembly.

In order to assemble the door latch assembly 40 of the present disclosure, the inside housing 70 is disposed by the installer to a position adjacent the interior surface 46 of the storage compartment door assembly 38 and proximate the opening 74 in the closable door panel 58 of the storage compartment door assembly 38. The outside housing 72 is similarly disposed by the installer to a position adjacent an exterior surface 44 of the storage compartment door assembly 38 and proximate the opening 74 in the closable door panel 58 of the storage compartment door assembly 38. The installer then aligns the plurality of resilient integral latch posts 130 with the plurality of integral receptacles 140, and subsequently pushes the inside housing 70 and the outside housing 72 together. By applying a predetermined force during assembly by simply pushing the resilient integral latch posts 130 on the outside housing 72 into the integral receptacles 140 disposed on the inside housing 70, the resilient integral latch posts 130 are displaced relative the integral receptacles 140, as describe above. This, in turn, moves the notches 148 on the resilient integral latch posts 130 forward and into registration and engagement with the catches 154 on the integral receptacles 140, whereby the resilient integral latch posts 130 are operably coupled with the integral receptacles 140 and the inside housing 70 and outside housing 72 are operably coupled one to the other, as perhaps best shown in FIGS. 6, 12A, and 12B, to retain the inside housing 70 and outside housing 72 in position on the exterior surface 44 and the interior surface 46 of the storage compartment door assembly 38.

As an additional feature of the construction herein described, preferably the resilient integral latch posts 130 may be manually disengaged from the integral receptacles 140 after assembly via the access provided by the openings 152. This is accomplished by displacing the distal end 150 of the resilient integral latch posts 130 to the side relative the opening 152 of the integral receptacles 140 to disengage the notch 148 from the catch 154 and thereby allow the withdrawal of the resilient integral latch posts 130 from the opening 152 of the integral receptacle 140. Preferably, such displacement of the resilient integral latch posts 130 is accomplished via a simple hand tool, such as a screwdriver. Moreover, given the location of the openings 154 of the integral receptacle 140 on the inside housing 70, which is inaccessible when the storage compartment door assembly 138 is in the closed position and the door latch assembly 40 is in the latched position, the door latch assembly 40 cannot be readily disassembled from outside the recreational vehicle 10. The door latch assembly 40 disclosed herein thus does not permanently interfere with serviceability of the storage compartment door assembly 138 or door latch assembly 40, yet still provides reliable door latch assembly 40 retention in the normally closed position subsequent assembly.

Alternatively, the components for the door latch assembly 40 may be reversed, and the resilient integral latch posts 130 may be mounted on the inside housing 70, while the integral receptacles 140 may mounted on the outside housing 72. However, in this configuration, the integral receptacles 140 may be preferably integrally molded as a blind hole, as noted above, which would then be inaccessible from an exterior surface 170 of the outside housing, in order to prevent tampering with the door latch assembly 40 and separation of the outside housing 72 from the inside housing 70, as discussed above.

Another particularly advantageous feature of the present disclosure is that each of the inside housing 70 and outside housing 72 may be preferably comprised of an integrated injection molded polymeric material within which each of the resilient integral latch posts 130 and integral receptacles 140 may be readily integrally molded, respectively. Preferably, each is fabricated from nylon, although it is contemplated that polypropylene (PP), thermoplastic polyolefin (TPO), compositions of PP and TPO, or blends thereof, with and without additional fillers, may also be used.

As a feature of the construction herein described, the plurality of resilient integral latch posts 130 and the plurality of integral receptacles 140 may be simply incorporated in the molds for these components and molded-in during the injection molding process. These molded-in features may be designed with existing die draft orientations. Thus, there are no incremental tooling costs or additional component complexities required to implement the improvement in the disclosed door latch assemblies 40. Indeed, the need for separate threaded fasteners is completely eliminated, as are the labor and material costs associated with the use of such separate threaded fasteners.

Accordingly, the door latch assembly 40 of the present disclosure provides an exceedingly elegant solution to the drawbacks of the prior art storage compartment door latch assemblies noted above. In particular, the disclosed door latch assembly 40 may be relatively quickly assembled, that is, by merely pushing the inside housing 70 and the outside housing 72 against each other, with the opening 74 for the door latch assembly 40 of the storage compartment door assembly 38 situated therebetween, as noted above. The foregoing disclosure provides a door latch assembly 40 that also effectively reduces misalignment during assembly, while simultaneously providing positive mechanical retention of the inside housing 70 relative the outside housing 72. Rather, proper alignment is readily obtained through the resilient integral latch posts 130 and integral receptacles 140 that are positioned internal to the door latch assembly 40. The foregoing disclosure further provides a door latch assembly 40 that may be simply disassembled should the need arise. Disassembly of the door latch assembly 40 is readily obtained by merely displacing the resilient integral latch posts 130 to the side relative the integral receptacles 140. Finally, the labor and material costs associated with separate threaded fasteners is eliminated. The disclosed door latch assembly 40 is thus obtained at minimal cost and complexity.

It will be understood by one having ordinary skill in the art that construction of the present disclosure and other components is not limited to any specific material. Other exemplary embodiments of the disclosure disclosed herein may be formed from a wide variety of materials, unless described otherwise herein.

For purposes of this disclosure, the term “coupled” or “operably coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the term “connected” or “operably connected” (in all of its forms, connect, connecting, connected, etc.) generally means that one component functions with respect to another component, even if there are other components located between the first and second component, and the term “operable” defines a functional relationship between components.

It is also important to note that the construction and arrangement of the elements of the present disclosure as shown in the exemplary embodiments is illustrative only. Although only a few embodiments of the present innovations have been described in detail in this disclosure, those skilled in the art who review this disclosure will readily appreciate that, unless otherwise described, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and storage compartments. Accordingly, all such modifications are intended to be included within the scope of the present innovations. Other substitutions, modifications, changes, and omissions may be made in the design, operating positions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

The invention claimed is:

1. A door latch assembly for a closure pivotable between an open position and a closed position, the door latch assembly comprising:
an inside housing and an outside housing in juxtaposed relation with one another and mounted to an opening in the closure to define an enclosure;
a resilient integral latch post substantially disposed upon and extending from one of the inside or outside housing and a corresponding integral receptacle substantially disposed upon the other of the inside or outside housing, wherein the integral receptacle is aligned with the resilient latch post so as to receive and restrain a notch on the resilient latch post upon a catch on the integral receptacle and thereby secure the inside and outside housing one to the other.

2. The door latch assembly of claim 1, wherein the resilient integral latch post or the integral receptacle further comprises a cam surface facing the other of the resilient integral latch post or the integral receptacle, whereby the resilient integral latch post is displaced by the cam surface to allow the resilient integral latch post to extend into the integral receptacle during and after assembly.

3. The door latch assembly of claim 2, wherein the resilient integral latch post and the integral receptacle each comprises a facing and interacting cam surface, whereby the resilient integral latch post is displaced to allow the resilient integral latch post to extend into the integral receptacle during and after assembly.

4. The door latch assembly of claim 1, wherein the notch on the resilient integral latch post is disposed at a distal end thereof and the catch on the integral receptacle is disposed on a portion of an edge of the integral receptacle upon which the notch is operably coupled after assembly.

5. The door latch assembly of claim 1, wherein the integral receptacle comprises an opening through which the resilient integral latch post extends during and after assembly.

6. The door latch assembly of claim 5, wherein the opening of the integral receptacle is substantially circular.

7. The door latch assembly of claim 5, wherein the opening of the integral receptacle is substantially rectangular.

8. The door latch assembly of claim 1, further comprising a plurality of resilient integral latch posts substantially disposed about and extending from a perimeter of the outside housing and a plurality of integral receptacles substantially disposed about a perimeter of the inside housing.

9. The door latch assembly of claim 8, wherein the plurality of integral receptacles comprise an opening though the inside housing through which the plurality of resilient integral latch posts extend during and after assembly.

10. The door latch assembly of claim 9, wherein the plurality of resilient integral latch posts are removable from the openings of the plurality of integral receptacles by displacing the notch on each of the plurality of resilient integral latch posts from the catch on each of the plurality of integral receptacles to allow the withdrawal of the plurality of resilient integral latch posts form the openings of the plurality of integral receptacles after assembly.

11. The door latch assembly of claim 1, wherein the inside housing and an outside housing operably connected to each other and through the opening in the closure, wherein the closure is disposed between the inside housing and an outside housing.

12. A door latch assembly comprising:
an inside housing and an outside housing in juxtaposed relation with one another and mounted to an opening in a closure to define an enclosure;
a retractable latch plunger situated within the enclosure;
a biasing member mounted within the enclosure urging the retractable latch plunger to an extended latched position;
an exterior handle assembly mounted to the outside housing and operably coupled with the retractable latch plunger, whereby the retractable latch plunger may be shifted between the latched position and an unlatched position; and
a plurality of resilient integral latch posts substantially disposed on the inside or outside housing and a corresponding plurality of integral receptacles substantially disposed on the other of the inside or outside housing, wherein the plurality of integral receptacles are aligned with the plurality of resilient integral latch posts so as to receive and restrain a notch on each of the plurality resilient integral latch posts upon a catch on each of the plurality of integral receptacles and thereby operably connect the inside and outside housing one to the other.

13. The door latch assembly of claim 12, wherein each of the plurality of resilient integral latch posts comprise a proximal end thereof integrally formed with the outside housing and the notch comprises a snap hook at a distal end thereof.

14. The door latch assembly of claim 13, wherein each of the plurality of resilient integral latch posts has a substantially rectangular body disposed between the proximal end and the distal end and the snap hook is substantially rectangular and each of the plurality of integral receptacles comprise a substantially rectangular opening.

15. The door latch assembly of claim 14, wherein the snap hook at the distal end of each of the plurality of resilient integral latch posts further comprises an undercut and a side edge portion of the opening of the plurality of integral receptacles further comprises a reverse incline to which the undercut of the snap hook is operably coupled.

16. The door latch assembly of claim 12, wherein the exterior handle assembly comprises a exterior paddle handle and a lock that restrains the exterior paddle handle and prevents operation of the retractable latch plunger.

17. The door latch assembly of claim 12, wherein the retractable latch plunger is slidably mounted within an elongated recess disposed on an inside surface of the inside housing.

18. The door latch assembly of claim 12, wherein the biasing member comprises a compression spring disposed in axial alignment with the retractable latch plunger within an elongated recess.

19. The door latch assembly of claim 12, wherein the retractable latch plunger comprises a main body received within an elongated recess disposed within the inside housing, and the retractable latch plunger further comprises an offset portion upon which a distal end of the retractable latch plunger is mounted such that the distal end of the retractable latch plunger is disposed adjacent an interior surface of the closure and a latch striker mounted proximate an edge of the opening in the closure.

20. A method of assembling a door latch assembly for a closure pivotable between an open position and a closed position, wherein the door latch assembly comprises:
an inside housing and an outside housing in juxtaposed relation with one another and mounted to an opening in the closure to define an enclosure, wherein the opening in the closure is smaller than an outer periphery of each of the inside housing and an outside housing;
a retractable latch plunger situated within the enclosure;
a biasing member mounted within the enclosure urging the retractable latch plunger to an extended latched position;
an exterior handle assembly mounted to the outside housing and operably coupled with the retractable latch plunger, whereby the retractable latch plunger may be shifted between the latched position and an unlatched position;
a plurality of resilient integral latch posts extending from the outside housing, each of the plurality of resilient integral latch posts further comprising a notch disposed at a distal end; and
a corresponding plurality of integral receptacles, each of the plurality of integral receptacles comprising an opening disposed on the inside housing, the opening further defining a catch on an edge thereof,
wherein the method comprises the steps of:
disposing the inside housing adjacent an interior surface of the closure and proximate the opening in the closure;
disposing the outside housing adjacent an outside surface of the closure and proximate the opening in the closure;
aligning the plurality of resilient integral latch posts with the plurality of integral receptacles; and
moving the inside housing and the outside housing together to push the notch on each of the plurality of resilient integral latch posts into registration with the catch on the plurality of integral receptacles and thereby operably couple the inside and outside housing one to the other.

21. The method of assembling a door latch assembly of claim 20, wherein at least one of the plurality of resilient integral latch posts or the plurality of integral receptacles each comprise an inclined cam surface, whereby the inclined cam surface displaces the plurality of resilient integral latch posts toward a central axis of the opening of the plurality of integral receptacles during the step of moving the inside housing and the outside housing together.

22. The method of assembling a door latch assembly of claim 21, wherein both the plurality of resilient integral latch posts and the plurality of integral receptacles each comprise an inclined cam surface, whereby the inclined cam surfaces displace the plurality of resilient integral latch posts toward the central axis of the opening of the plurality of integral receptacles during the step of moving the inside housing and the outside housing together.

23. The method of assembling a door latch assembly of claim 21, wherein a snap hook is disposed at the distal end of each of the plurality of resilient integral latch posts, the snap hook further comprising an undercut, and an edge portion of the opening of the plurality of integral receptacles further comprises a reverse incline to which the undercut of the snap hook is operably coupled after the step of moving the inside housing and the outside housing together.
